(19) United States
(12) Patent Application Publication
(10) Pub. No.: US 2025/0060446 A1
(43) Pub. Date: Feb. 20, 2025

(54) METHOD OF ESTIMATING A DIRECTION OF ARRIVAL OF AN ELECTROMAGNETIC WAVE AT AN ANTENNA ARRAY

(71) Applicant: SAFRAN ELECTRONICS & DEFENSE, PARIS (FR)

(72) Inventors: Pierre-Antoine GARCIA, MOISSY-CRAMAYEL (FR); Arnaud LILBERT, MOISSY-CRAMAYEL (FR); Alain Michel CHIODINI, MOISSY-CRAMAYEL (FR)

(73) Assignee: SAFRAN ELECTRONICS & DEFENSE, PARIS (FR)

(21) Appl. No.: 18/720,998

(22) PCT Filed: Dec. 13, 2022
(86) PCT No.: PCT/FR2022/052337

§ 371 Date: Jun. 17, 2024

(30) Foreign Application Priority Data
Dec. 17, 2021 (FR) FR2113624

(51) Int. Cl. G01S 3/08; G01S 3/04; G01S 3/46

(52) U.S. Cl. CPC G01S 3/08; G01S 3/043; G01S 3/46

(57) ABSTRACT

The invention relates to a method for estimating the direction of arrival of an electromagnetic wave at an antenna array (2), comprising the steps of: —estimating (202) a covariance matrix of signals acquired by the antenna array (2); —calculating (204) a normalised eigenvector of the covariance matrix; —correlating (205) the normalised eigenvector with a first reference table and a second reference table so as to produce a first correlation spectrum and a second correlation spectrum comprising correlation indices associated, respectively, with different directions of arrival; —constructing (312) a third reference table by linear combination of the first reference table and the second reference table with a polarisation component of the electromagnetic wave in the first direction and the second direction, respectively; —correlating (314) the normalised eigenvector with the third reference table so as to produce a third correlation spectrum comprising correlation indices associated with different directions of arrival; —identifying (316) a direction of arrival associated with a maximum correlation index of the third correlation spectrum.

### FIELD OF THE INVENTION

The present invention relates to a method of estimating a direction of arrival of an electromagnetic wave at an antenna array.

### Prior Art

Methods for estimating the direction of arrival of an electromagnetic wave at an antenna array are known from the prior art.

Some of these methods involve an array of antennas all polarised vertically or horizontally. However, when the polarisation of the incident wave differs from the vertical or horizontal polarisations, the estimation of the direction of arrival is biased, which is all the more true when the cross-polarisation component of the receiving antennas cannot be controlled, particularly during incorporation on a carrier. The choice of a method therefore depends on the capacity of the antenna array to operate over all linear or even elliptical polarisations.

In particular, document EP2435847 describes a method of estimating the direction of arrival of an electromagnetic wave at an array of differently polarised antennas, which comprises steps leading to a cost function C(Xj). This cost function is the result of the sum of two squared terms. This cost function can be represented by a curve, with Xj as the abscissa and C(Xj) as the ordinate. A value X₀ is associated with a maximum of this curve is identified, the value X₀ constituting an estimate of the direction of arrival of the electromagnetic wave.

However, this method does not jointly estimate the direction of arrival and the polarisation of the incident wave.

### DISCLOSURE OF THE INVENTION

An aim of the present disclosure is to obtain a more precise estimate of the direction of arrival of an electromagnetic wave at an antenna array.

For this purpose, according to a first aspect, a computer-implemented method is proposed for estimating the direction of arrival of an electromagnetic wave at an antenna array, the method comprising steps of:
estimating a covariance matrix of signals acquired by the antenna array, the signals coming from the electromagnetic wave,
calculating a normalised eigenvector of the covariance matrix, the eigenvector being associated with an eigenvalue of the covariance matrix,
correlating the normalised eigenvector with a first reference table A_{V} so as to produce a first correlation spectrum comprising correlation indices respectively associated with different directions of arrival, the first reference table comprising normalised responses of the antenna array to a first reference electromagnetic wave polarised in a first direction and respectively associated with different directions of arrival of the first reference electromagnetic wave,
correlating the normalised eigenvector with a second reference table so as to produce a second correlation spectrum comprising correlation indices respectively associated with different directions of arrival, the second reference table comprising normalised responses of the antenna array to a second reference electromagnetic wave polarised in a second direction respectively associated with different directions of arrival of the second reference electromagnetic wave, the second direction being different from the first direction,
constructing a third reference table by linear combination of the first reference table and the second reference table, respectively having a polarisation component of the electromagnetic wave in the first direction and a polarisation component of the electromagnetic wave in the second direction,
correlating the normalised eigenvector with the third reference table so as to produce a third correlation spectrum comprising correlation indices associated with different directions of arrival,
identifying a direction of arrival associated with a maximum correlation index of the third correlation spectrum.

An advantage of the proposed method is that it jointly proposes to jointly estimate the direction of arrival and the polarisation of the incident wave, which enables, with the choice of the appropriate antenna array, an incorporation of the latter very near the carrier vehicle.

The method according to the first aspect can also comprise the following features, taken alone or in combination when this is technically possible.

Preferably, the method according to the first aspect further comprises steps of:
selecting a direction of arrival associated with a maximum correlation index of the first correlation spectrum or of the second correlation spectrum,
constructing a polarisation lookup table on the basis of a first normalised response of the antenna array to the first reference electromagnetic wave, the first normalised response being associated in the first reference table with the selected direction of arrival, and on the basis of a second normalised response of the antenna array to the second reference electromagnetic wave, the second normalised response being associated in the second reference table with the selected direction of arrival,
correlating the normalised eigenvector with the polarisation lookup table, so as to obtain a fourth correlation spectrum comprising correlation indices associated with different complex values,
adjusting the polarisation component of the electromagnetic wave in the second direction to a complex value associated with a maximum correlation index of the fourth correlation spectrum, then normalising a polarisation vector formed by the polarisation components of the electromagnetic wave in the first direction and the polarisation component of the electromagnetic wave in the second direction, the construction of the third reference table being implemented after the normalisation of the polarisation vector.

Preferably, the first correlation spectrum comprises a first maximum correlation index and the second correlation spectrum comprises a second maximum correlation index, and the selected direction of arrival at the selection step is:
a direction of arrival associated with the first maximum correlation index in the first correlation spectrum, when the first maximum correlation index is greater than the second maximum correlation index,
a direction of arrival associated with the second maximum correlation index in the second correlation spectrum, when the first maximum correlation index is not greater than the second maximum correlation index.

Preferably, the method according to the first aspect comprises creating a lookup space comprising various values for a complex variable, and wherein the construction of the polarisation lookup table comprises a linear combination of the first response and second response with respectively the polarisation component of the electromagnetic wave in the first direction and a weighting factor dependent on the modulus of the second polarisation component of the electromagnetic wave and the various values for the complex variable, the linear combination being repeated for each of the various values.

Preferably, the method according to the first aspect comprises steps of:
updating the selected direction of arrival to the value of the identified direction of arrival,
updating the lookup space to a new lookup space including the polarisation component of the electromagnetic wave in the second direction of the polarisation vector obtained at the end of the normalisation step, then
repeating the steps of selecting, constructing a polarisation lookup table, correlating the normalised eigenvector with the polarisation lookup table, adjusting, constructing a third reference table, correlating the normalised eigenvector with the third reference table, and identifying a direction of arrival.

Preferably, the lookup space forms a spiral in the complex plane, and updating the lookup space comprises dilation of the spiral, so that the new lookup space forms a new spiral in the complex plane, which is dilated with respect to the spiral.

Preferably, the method according to the first aspect further comprises a comparison between the maximum correlation index of the third correlation spectrum Sₚₚ, and a predefined threshold, said repetition only being implemented if the maximum correlation index of the third correlation spectrum is less than the predefined threshold.

Preferably, the first direction and the second direction are orthogonal.

According to a second aspect, a computer-readable memory is also proposed, storing instructions executable by the computer in order to control the execution of the steps of the method according to the first aspect.

According to a third aspect, a device is also proposed for estimating the direction of arrival of an electromagnetic wave at an antenna array, the estimation device comprising at least one processor configured to implement the method according to the first aspect.

According to a fourth aspect, a system is proposed, comprising:
an antenna array configured to acquire signals coming from an electromagnetic wave,
a device for estimating the direction of arrival of the electromagnetic wave at the antenna array on the basis of the signals, the estimation device being in accordance with the third aspect.

A mobile carrier is also proposed, such as an aircraft, comprising a system according to the fourth aspect.

### DESCRIPTION OF THE FIGURES

Other features, aims and advantages of the invention will emerge from the following description, which is given purely by way of illustration and not being limiting and which should be read with reference to the attached drawings, in which:

FIG. 1 schematically illustrates a system according to an embodiment.

FIG. 2 is a flow diagram of steps of a method which can be implemented by the system of FIG. 1.

FIG. 3 is a flow diagram of steps of a method for estimating the direction of arrival of an electromagnetic wave at an antenna array, according to an embodiment.

FIG. 4 is a diagram representing eigenvalues and associated indices, these eigenvalues being involved in the method of FIG. 3.

FIG. 5 shows two curves formed by correlation spectra S_{PV}, S_{PH} calculated during an implementation of the method of FIG. 3.

FIG. 6 is a flow diagram detailing an embodiment of a step of the method of FIG. 3.

FIG. 7 shows a lookup space for a complex variable p, in the complex plane.

FIG. 8a shows a curve formed by a spectrum Sₚ calculated during an iteration of the method of FIG. 3, this spectrum being a function of the complex variable p.

FIG. 8b shows the two curves of FIG. 5 as well as a curve formed by another correlation spectrum Sₚₚ, calculated during an iteration of the method of FIG. 3.

FIG. 9a shows a curve formed by a spectrum Sₚ calculated during another iteration of the method of FIG. 3, this spectrum being a function of the complex variable p.

FIG. 9b shows the two curves of FIG. 5, as well as a curve formed by another correlation spectrum S_{PP} calculated during another iteration of the method of FIG. 3.

In all the figures, similar elements have identical reference signs.

### DETAILED DESCRIPTION OF THE INVENTION

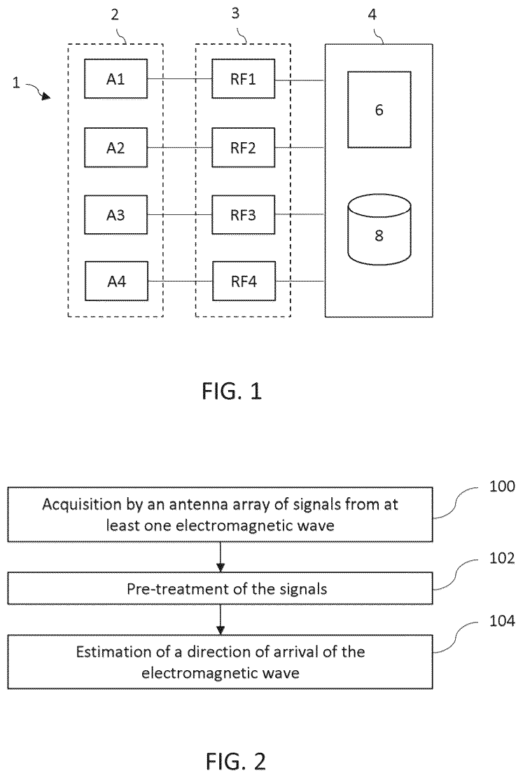

With reference to FIG. 1, a system 1 comprises an antenna array 2, a plurality of channels 3 and a device 4 for estimating the direction of arrival of an electromagnetic wave at the antenna array 2.

The antenna array 2 comprises a plurality of radio antenna elements A1-A4 (four antenna elements in the non-limiting example illustrated). Any number of antennas is possible.

Each antenna element of the antenna array 2 is connected to the estimation device by one of the channels forming part of the plurality of channels 3. Each channel can comprise components known to a person skilled in the art, which process signals acquired by the corresponding antenna element. These components typically comprise an RF front end, and an analogue digital-to-analogue converter downstream of the RF front end. An RF front end is shown on each channel in FIG. 1, these front-ends being designated by reference signs RF1 to RF4.

The estimation device is designed to receive signals having passed through the plurality of channels 3.

The estimation device 4 comprises at least one processor 6 and a memory 8.

The, or each, processor 6 is configured to execute a program for estimating a direction of arrival, comprising code instructions. During this execution, the processor implements a method for estimating the direction of arrival, which will be described below.

The memory 8 can be read by the or each processor, and stores the program for estimating the direction of arrival.

Furthermore, a first reference table A_{V} and a second reference table A_{H} are also stored in the memory.

The first reference table A_{V} comprises normalised responses of the antenna array 2 to a first reference electromagnetic wave polarised in a first polarisation direction, the responses being respectively associated with different directions of arrival of the first reference electromagnetic wave.

In the present disclosure, a direction of arrival refers implicitly to an orientation in space, in other words angular data. For example, a direction of arrival can be characterised by an angle of azimuth and an angle of elevation.

The first reference table A_{V} is obtained by a calibration method comprising the following steps. A transmitter is placed at a certain distance from the antenna array 2, in a predetermined position. The transmitter emits the first reference electromagnetic wave discussed above, in other words a wave polarised in the first polarisation direction. This wave is received by the antenna array 2 in a certain direction of arrival. Signals are acquired by the antenna array 2 on the basis of this wave, and these signals are processed in order to obtain a vector constituting a normalised response of the antenna array 2 to the first reference wave, this vector being associated with the direction of arrival of the wave. Then, the transmitter is placed in a new position, by rotating the transmitter about the antenna array 2 by a certain angular step. The preceding steps are repeated once the transmitter is in this new position so as to obtain a new vector associated with a new direction of arrival of the first reference wave. By repeating these steps for different positions of the transmitter around the antenna array 2, a plurality of vectors is obtained, which forms the reference table A_{V}.

Similarly, the second reference table A_{H} comprises normalised responses of the antenna array 2 to a second reference electromagnetic wave polarised in a second polarisation direction, the responses being respectively associated with different directions of arrival of the second reference electromagnetic wave.

The second reference electromagnetic wave differs from the first reference electromagnetic wave. More specifically, the second polarisation direction is different from the first polarisation direction. In addition, the second reference wave may have a polarisation of inclination and/or ellipticity different from the first reference electromagnetic wave.

The second reference table A_{H} is obtained by the same calibration method as that used to obtain the first reference table A_{V}, except that the reference wave emitted by the transmitter is polarised in the second direction, and not in the first direction.

In what follows, it is assumed that the second polarisation direction is perpendicular to the first polarisation direction, it being understood that this is a non-limiting example. In that which follows, the first polarisation direction will be called the “vertical direction”, and the second polarisation direction will be called the “horizontal direction”.

The system 1 can advantageously be used for receiving signals emanating from positioning satellites (GNSS). In this particular application, estimating the direction of arrival of an electromagnetic wave is useful for detecting jamming or decoying.

The system 1 can typically be installed in a mobile carrier, such as an aircraft.

A method implemented by the system 1 is now described in relation to FIG. 2. This method comprises the following steps.

In an acquisition step 100, the antenna array 2 receives at least one electromagnetic wave being propagated in a certain direction, this wave transporting a payload signal. By convention, the direction of arrival of a wave is called the direction of propagation of such a wave at the time when the wave reaches the antenna array 2. This direction of arrival is not known a priori by the system 1.

Each electromagnetic wave received by the antenna array 2 is polarised in a certain direction, referred to below as the polarisation direction. This polarisation direction is not known a priori, but may be expressed in the form of a polarisation vector P, called a Jones vector in the literature. The polarisation vector P comprises a polarisation component P1 in the first direction (vertical component) and a component P2 in the second direction (horizontal component). Thus, the determination of these two components P1, P2 would make it possible to know the polarisation direction of the electromagnetic wave.

An electromagnetic wave may, for example, have been emitted by a positioning satellite that is part of a constellation of satellites GNSS (GPS, GALILEO, GLONASS, etc.).

The antenna array 2 produces analogue signals coming from the electromagnetic wave. More precisely, each antenna element of the antenna array 2 produces an analogue electrical signal on the basis of the received electromagnetic wave.

In a pre-processing step 102, the N analogue signals are processed by the channels 3. In particular, the N analogue signals are converted into N digital signals, each digital signal comprising T samples.

The analogue signals form an acquisition matrix X comprising N rows and T columns. This acquisition matrix X contains a noisy signal S. The acquisition matrix X can be broken down as follows:

$$X = AS + B$$

where A is a matrix representative of the response of the system 1 (in particular the response of the antenna array 2 and the plurality of channels 3), and where B is noise.

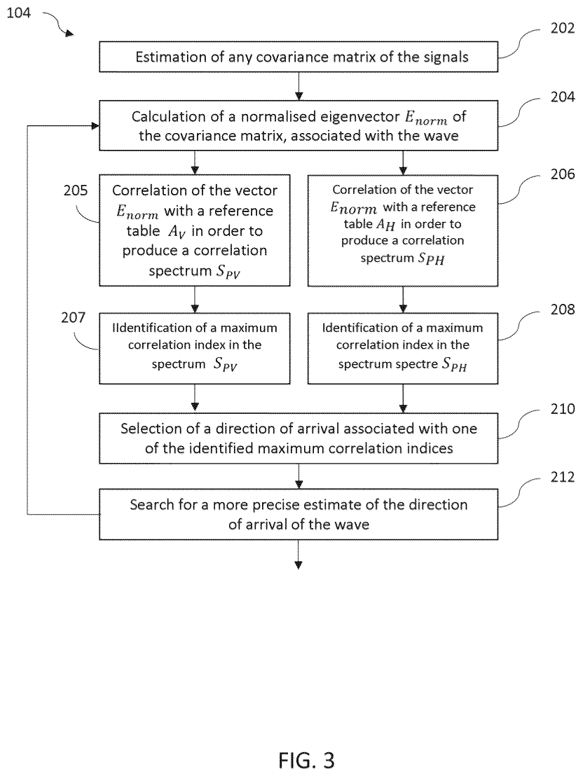

In a step 104, the estimation device 4 implements a method estimating the direction of arrival of the electromagnetic wave received by the antenna array 2. With reference to FIG. 3, this estimation method 104 comprises the following steps.

In a step 202, the estimation device 4 calculates an estimate [symbol] of the covariance matrix of the digital signals. For this purpose, the estimation device 4 applies the following calculation:

$$= \frac{1}{T} {XX}^{H}$$

Here, the operator H designates the transposition of a matrix and the conjugation of the values of this transposed matrix (“conjugate transpose” operator).

In a step 204, the estimation device 4 calculates at least one normalised eigenvector Fₙₒᵣₘ of the covariance matrix, the eigenvector being associated with an eigenvalue of the covariance matrix.

When a single wave has been received by the antenna array 2 during the acquisition step 100, a single vector Eₙₒᵣₘ is calculated in step 204.

In this case, the vector Fₙₒᵣₘ can be obtained by using and normalising a column of the covariance matrix, for example its first column. In this case, the estimation device 4 performs the following calculations:

$$E = ( : 1 )$$

$${E}_{norm} = \frac{E}{\sqrt{{E}^{H} E}}$$

When a plurality of waves has been received simultaneously by the antenna array 2 during the acquisition step 100, one or more vectors Eₙₒᵣₘ can be calculated in step 204, each calculated vector being associated with a received electromagnetic wave.

In this case, the different vectors Eₙₒᵣₘ are calculated in step 204 in the following manner.

The estimation device 4 decomposes the estimate of the covariance matrix [symbol] into singular values (this decomposition being generally abbreviated in the literature by SVD, for “singular value decomposition”). The properties of [symbol] are such that:

[symbol]

=UΣV^{H}

where:
U designates the matrix containing the so-called “left” eigenvectors
Σ designates the matrix containing the eigenvalues
V^{H} designates the matrix containing the so-called “right” eigenvectors

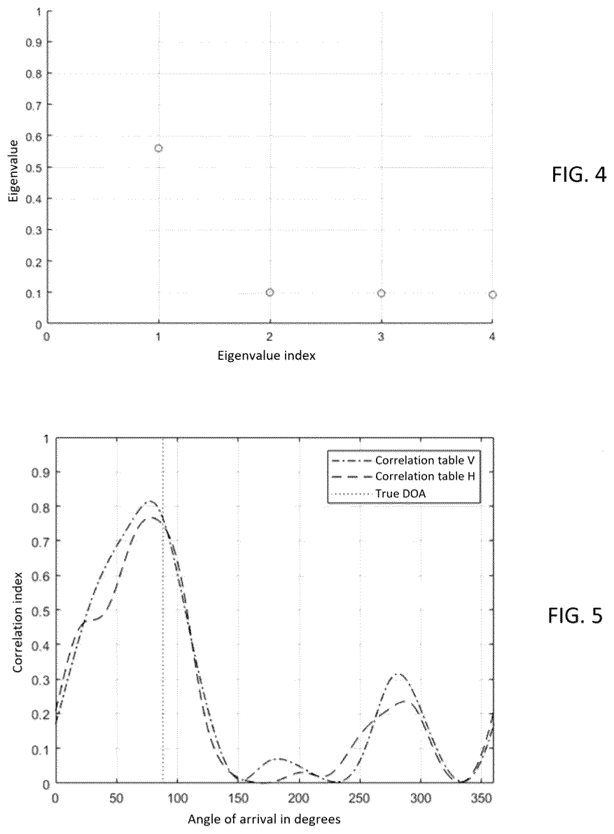

The analysis of the eigenvalues located on the diagonal of the matrix 1 makes it possible to decide how many eigenvectors (vectors columns of the matrix U) can be assigned to a vector Eₙₒᵣₘ. This analysis step is called “enumeration” For any eigenvalue Σ(N,N) greater than a threshold, the associated eigenvector U(:,N) is associated with a vector Eₙₒᵣₘ (the normalisation step is natural during the decomposition into singular values). FIG. 4 illustrates an example of enumeration in which there are four eigenvalues. In this example, only the first eigenvector is assigned to a vector EEₙₒᵣₘ, i.e.:

Eₙₒᵣₘ=U(:,1)

In the following, processes are detailed which are applied to a vector Eₙₒᵣₘ calculated in step 204. It is understood that this processing can be repeated for each vector Eₙₒᵣₘ calculated in step 204, if there are more than one.

In a correlation step 205, the device correlates the vector Eₙₒᵣₘ with the first reference table A_{V} so as to produce a first correlation spectrum S_{PV} comprising correlation indices respectively associated with different directions of arrival.

In a correlation step 206, the estimation device 4 correlates the vector Eₙₒᵣₘ with the second reference table A_{H} so as to produce a second correlation spectrum S_{PH} comprising correlation indices respectively associated with different directions of arrival.

These correlations 205, 206 can be produced via the following calculations:

S_{PV}=(abs(A_{V}^{H}Eₙₒᵣₘ))²

S_{PH}=(abs(A_{H}^{H}Eₙₒᵣₘ))²

In these expressions, “abs” designates an absolute value.

The correlations 205, 206 can be implemented in parallel or sequentially.

In FIG. 5, two curves are shown which represent examples of spectra S_{PV} and S_{PH} obtained from a reference electromagnetic wave, for which the direction of arrival was known in advance. The correlation indices are the ordinates, and the associated directions of arrival are expressed in the abscissa as angles in degrees. It is observed that the curves representing spectra S_{PV} and S_{PH} have maxima rather close to the true direction of arrival of the electromagnetic wave received by the antenna array 2 at the acquisition step. However, these two maxima are different, and do not precisely correspond to the true direction of arrival of this wave.

The aim of the following steps of the method is simply to precisely estimate the true direction of arrival from the two correlation spectra, spectra S_{PV} and S_{PH}.

In a step 207, the estimation device 4 identifies the maximum correlation index of the first correlation spectrum.

In a step 208, the estimation device 4 identifies the maximum correlation index of the second correlation spectrum.

In a step 210, the estimation device 4 selects a direction of arrival associated with a maximum correlation index of the first correlation spectrum or the second correlation spectrum.

Advantageously, during step 210, the estimation device 4 compares the maximum correlation index of the spectrum S_{PV} with the maximum correlation index of the spectrum S_{PH}, and selects the largest of the two. The direction selected is that associated with the largest of the two maxima. This particular selection can converge more rapidly towards a precise estimate of the direction of arrival of the received electromagnetic wave.

In a step 212, the estimation device 4 searches for a more precise estimate of the direction of arrival of the electromagnetic wave received by the antenna array.

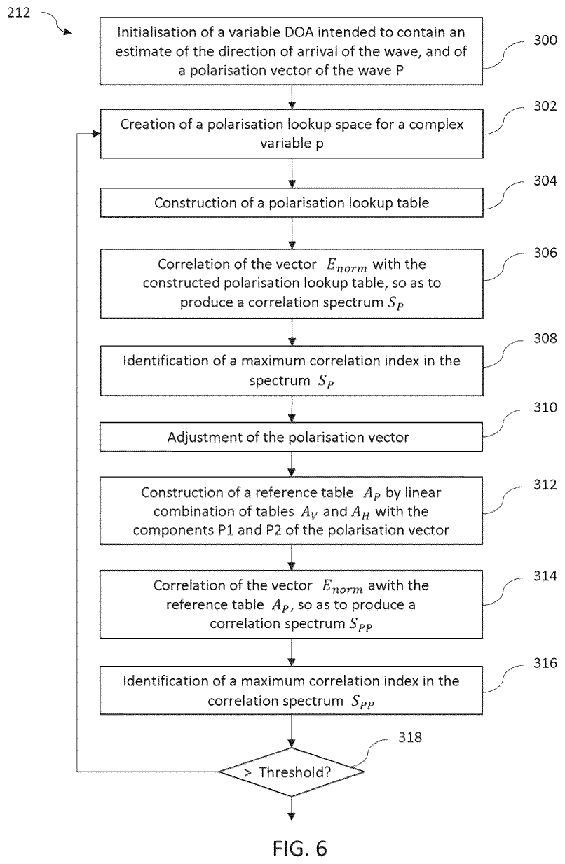

With reference to FIG. 6, this search 212 comprises an initialisation step 300.

During the initialisation step 300, the estimation device 4 initialises a variable DOA intended to contain an estimate of the direction of arrival of the received electromagnetic wave. This variable DOA is initialised using the direction of arrival selected during step 210.

Furthermore, during the initialisation step 300, the estimation device 4 initialises a polarisation vector P=[P1 P2] of the wave. More precisely, the vertical polarisation component P1 and the horizontal polarisation component P2 of this vector P are initialised to initial values. At this stage, the polarisation of the received electromagnetic wave is not known; the initial values of the polarisation vector P of this wave do not therefore reflect reality.

The search 212 comprises an iterative loop after the initialisation 300. As will be seen below, this iterative loop provides not only a precise estimate of the direction of arrival of the electromagnetic wave received by the antenna array, but also provides a precise estimate of the direction of polarisation of this wave.

In general, an iteration of the loop takes as input the variable DOA and the polarisation vector P.

In particular, the first iteration of the iterative loop takes as input the selected direction of arrival preceding the step 210 (and which, as has been seen, needs to be refined) and the polarisation vector P as initialised (and which therefore does not constitute a good estimate of the polarisation direction of the received electromagnetic wave).

The first iteration (iteration index 1) comprises the following steps.

In a step 302, the estimation device 4 creates a lookup space for a complex variable p. This lookup space includes the initial value of the component P2 (considered as a complex number) which has been obtained at the end of the initialisation 300.

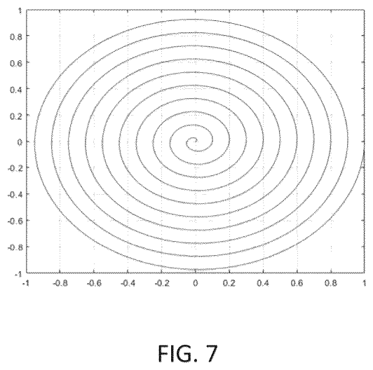

Advantageously, the lookup space forms a spiral in the complex plane, as in the example of FIG. 7. In other words, the lookup space comprises a plurality of values for the complex variable p, this plurality of values being able to be represented as a plurality of points which are located on such a spiral (the real part of a value is the abscissa and the imaginary part of this value is the ordinate in the complex plane).

The spiral is characterised by two parameters: a range of angles of travel of the spiral (variable parameter which will influence the number of turns travelled by the spiral), and a coefficient of normalisation of the size of the spiral (fixed parameter). The maximum radius of p is 1.

In a step 304, the estimation device 4 then constructs a polarisation lookup table.

In order to construct this polarisation lookup table in step 304, the estimation device 4 determines a first normalised response of the antenna array 2 at the first (vertically polarised) reference electromagnetic wave, the first normalised response being associated, in the first reference table A_{y}, with the direction of arrival contained in the variable DOA (this direction of arrival being that having been selected before the iterative loop in the case of the first iteration of the loop).

It has been seen above that the first reference table A_{V} comprises normalised responses of the antenna array 2 to the first (vertically polarised) reference electromagnetic wave, these normalised responses being associated with different directions of arrival of the first reference electromagnetic wave. The first normalised response is the vector which is specifically associated with the direction of arrival having been previously selected. This first response can constitute a column of the first reference table A_{V}, or else be calculated on the basis of the contents of this table. In a way, the first reference table A_{V} can be seen as a function Table1 ( ) which indicates how a normalised response evolves as a function of a direction of arrival. This is why the first normalised response is denoted Table1(DOA).

Furthermore, in order to construct the polarisation lookup table in step 304, the estimation device 4 determines a second normalised response of the antenna array 2 to the second reference electromagnetic wave, the second normalised response being associated in the second reference table A_{H} with the direction of arrival contained in the variable DOA. This second normalised response is denoted Table2(DOA).

The polarisation lookup table is calculated from the first normalised response Table1(DOA), the second normalised response Table2(DOA), the parameter R and the complex variable p.

More precisely, the polarisation lookup table results from the following calculation implemented by the estimation device 4, for each value of the complex variable p that is part of the lookup space created in step 302:

$$P 1 * Table 1 ( DOA ) + R * p * \vert P 2 \vert * Table 2 ( DOA )$$

In this equation, the asterisk * designates a multiplication, |P2|designates the modulus of P2, considered to be a complex number, and R designates a coefficient of expansion of the spiral discussed above. R has a value of 1 at the first implementation of step 304.

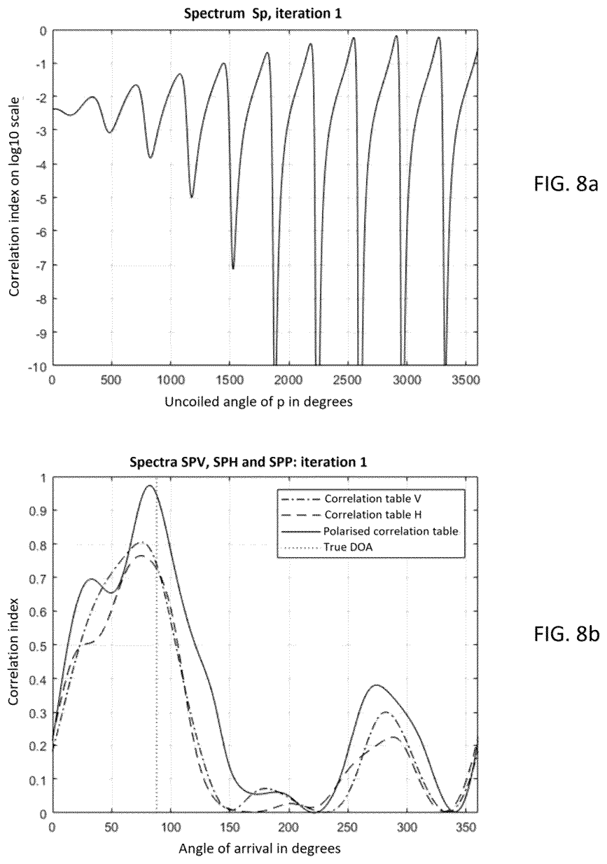

In a correlation step 306, the estimation device 4 correlates the normalised eigenvector Eₙₒᵣₘ with the polarisation lookup table thus constructed, so as to obtain a correlation spectrum Sₚ comprising correlation indices associated with different complex values of the variable p. This correlation spectrum Sₚ, an example of which is shown in FIG. 8a, is not of the same nature as the spectra S_{PV} and S_{PH}, because it shows a correlation as a function of a polarisation variable p, and not as a function of a direction of arrival.

In a step 308, the estimation device 4 identifies a maximum correlation index of the correlation spectrum Sₚ, as well as the associated complex value p2.

In an adjustment step 310, the estimation device 4 adjusts the vector P in the following manner: the component P2 is adjusted to the complex value p2 associated with the maximum correlation index of the correlation spectrum Sₚ, then the vector thus obtained is normalised. In the course of this normalisation, the components P1 and P2 are adjusted so that the norm of the vector is equal to 1.

The vector P thus obtained after this adjustment step 310 constitutes a more precise estimate (in other words closer to the genuine polarisation direction of the received electromagnetic wave) than the vector P before its adjustment.

In a construction step 312, the estimation device 4 constructs a third reference table A_{P} by linear combination of the first reference table A_{V} and the second reference table A_{H} with the component P1 and the component P2 respectively, after the polarisation vector P has been adjusted in step 310.

This linear combination is expressed as:

$${A}_{P} = P 1 * {A}_{V} + P 2 * {A}_{H}$$

or, if the Table1 and Table2 notations are used again to designate the two above-mentioned reference tables:

$${A}_{P} = P 1 * Table 1 + P 2 * Table 2$$

As will be illustrated below, the table A_{P} resulting from this linear combination constitutes a more reliable base than the reference tables A_{V} and A_{H}, for more precisely estimating the direction of arrival of the received electromagnetic wave.

In a correlation step 314, the estimation device 4 correlates the normalised eigenvector Eₙₒᵣₘ with the reference table A_{P} so as to produce a correlation spectrum Sₚₚ comprising correlation indices associated with different directions of arrival. This correlation step 316 is similar to steps 205 and 206.

FIG. 8b illustrates the curves representative of the spectra S_{PV} and S_{PH} of FIG. 4 superimposed on a curve representative of the correlation spectrum Sₚₚ calculated during the first implementation of step 314. It is observed that the curve representing the spectrum Sₚₚ has a maximum much closer to the real direction of arrival of the electromagnetic wave received by the antenna array 2 than the maxima of spectra S_{PV} and S_{PH}.

In a step 316, the estimation device 4 identifies a maximum correlation index of the correlation spectrum Sₚₚ. The variable DOA is adjusted to the direction of arrival associated with this maximum index.

The direction of arrival associated with the maximum correlation index of the correlation spectrum Sₚₚ constitutes a new estimate of the direction of arrival of the received electromagnetic wave, refined with respect to the selected direction of arrival in one of the spectra S_{PV} and S_{PH} in step 210.

In a step 318, the estimation device 4 compares the updated variable DOA with a predefined threshold.

If the updated variable DOA (containing the maximum correlation index of the correlation spectrum Sₚₚ) proves to be greater than the threshold, then the iterative loop is terminated. In this case, it is considered that the maximum of the correlation spectrum Sₚₚ identified in step 318 constitutes a sufficiently precise estimate of the direction of arrival of the received electromagnetic wave.

If, on the contrary, the updated variable DOA (containing the maximum correlation index of the correlation spectrum Sₚₚ) is not greater than the threshold, then a new iteration of the iterative loop is implemented (iteration with index 1).

The iteration with index 1 takes as input the variable DOA and the polarisation vector P as adjusted during the first iteration. In this new iteration, the steps 302, 304, 306, 308, 310, 312, 314, 316 and 318 are implemented again, as in the preceding iteration.

A new lookup space is created during the new implementation of the step 302, by updating the precedingly created lookup space. This new lookup space includes the component P2 (considered as a complex number) which was obtained at the end of the preceding implementation of step 310.

Preferably, the new lookup space forms a new spiral passing through the point P2 in the complex plane, the new spiral being expanded with respect to the preceding spiral. The term “expanded” means that the radial distance between two successive turns of the new spiral is greater than the radial distance between two successive turns of the preceding spiral. This expansion can be characterised by a expansion coefficient R>1. It is this new value of R which is then used during the calculation of a new polarisation lookup table, during step 304.

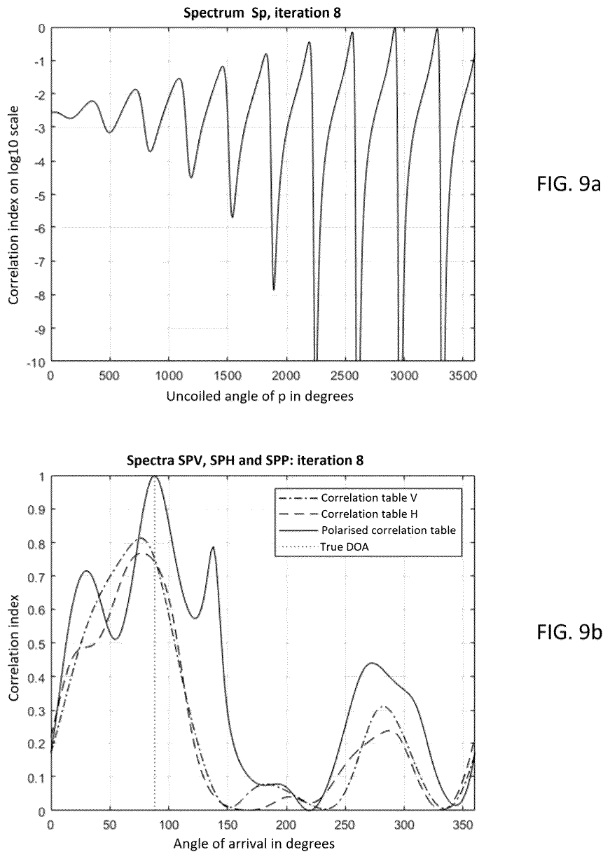

FIG. 9a illustrates a new correlation spectrum Sₚ obtained during an iteration with index 8, while FIG. 9b illustrates the spectra S_{PV} and S_{PH} obtained during this iteration with index 8. It is the last iteration in this embodiment (the iteration during which the predefined threshold is reached in step 318). It is observed that at the end of this iteration with index 8, the maximum of the correlation spectrum Sₚₚ is extremely close to the real direction of arrival of the wave, a sign of the very high precision of the implemented method.

An advantage of the above-described method is that it not only makes it possible to obtain a more precise estimate for the direction of arrival of the electromagnetic wave at the antenna array, but it also allows an estimate to be obtained of the polarisation direction of the electromagnetic wave.

The method as described above can however be the subject of variants. Although it is highly advantageous, the implementation of an iterative loop is not strictly necessary. An implementation of the steps forming part of an iteration of the loop previously described may be sufficient for obtaining a refined estimate of the direction of arrival of the received electromagnetic wave.

Furthermore, in the method as described above, the reference tables A_{V} and A_{H} contribute to refining the values of the components P1 and P2 of the polarisation vector, which is very advantageous. However, it is perfectly possible to calculate the reference table A_{P} on the basis of components P1 and P2 estimated in another manner.

1. A computer-implemented method of estimating a direction of arrival of an electromagnetic wave at an antenna array, the method comprising:
estimating a covariance matrix of signals acquired by the antenna array, the signals being derived from the electromagnetic wave,
calculating a normalised eigenvector of the covariance matrix, the eigenvector being associated with an eigenvalue of the covariance matrix,
correlating the normalised eigenvector with a first reference table so as to produce a first correlation spectrum comprising correlation indices respectively associated with different directions of arrival, the first reference table comprising normalised responses of the antenna array to a first reference electromagnetic wave polarised in a first direction and respectively associated with different directions of arrival of the first reference electromagnetic wave,
correlating the normalised eigenvector with a second reference table so as to produce a second correlation spectrum comprising correlation indices respectively associated with different directions of arrival, the second reference table comprising normalised responses of the antenna array to a second reference electromagnetic wave polarised in a second direction respectively associated with different directions of arrival of the second reference electromagnetic wave, the second direction being different from the first direction,
constructing a third reference table by linear combination of the first reference table and the second reference table, with a polarisation component of the electromagnetic wave in the first direction and with a polarisation component of the electromagnetic wave in the second direction, respectively,
correlating the normalised eigenvector with the third reference table so as to produce a third correlation spectrum comprising correlation indices associated with different directions of arrival,
identifying a direction of arrival associated with a maximum correlation index of the third correlation spectrum.

2. The method of claim 1, further comprising:
selecting a direction of arrival associated with a maximum correlation index of the first correlation spectrum or of the second correlation spectrum,
constructing a polarisation lookup table from a first normalised response of the antenna array to the first reference electromagnetic wave, the first normalised response being associated in the first reference table with the selected direction of arrival, and from a second normalised response of the antenna array to the second reference electromagnetic wave, the second normalised response being associated in the second reference table with the selected direction of arrival,
correlating the normalised eigenvector with the polarisation lookup table, so as to obtain a fourth correlation spectrum comprising correlation indices associated with various values of a complex variable,
adjusting the polarisation component of the electromagnetic wave in the second direction to a complex value associated with a maximum correlation index of the fourth correlation spectrum, then normalising a polarisation vector formed by the polarisation component of the electromagnetic wave in the first direction and the polarisation component of the electromagnetic wave in the second direction,
wherein constructing the third reference table is carried out after normalizing the polarisation vector.

3. The method of claim 2, wherein the first correlation spectrum comprises a first maximum correlation index and the second correlation spectrum comprises a second maximum correlation index, and wherein the selected direction of arrival at the selection step is:
a direction of arrival associated with the first maximum correlation index in the first correlation spectrum whenever the first maximum correlation index is greater than the second maximum correlation index,
a direction of arrival associated with the second maximum correlation index in the second correlation spectrum whenever the first maximum correlation index is not greater than the second maximum correlation index.

4. The method of claim 2, comprising creating a lookup space comprising various values for the complex variable, and wherein constructing the polarisation lookup table comprises a linear combination of the first response and second response with respectively the polarisation component of the electromagnetic wave in the first direction and a weighting factor dependent on a modulus of the second polarisation component of the electromagnetic wave and one of the various values for the complex variable, the linear combination being repeated for each of the various values.

5. The method of claim 4, comprising:
updating the selected direction of arrival to the value of the identified direction of arrival,
updating the lookup space into a new lookup space including the polarisation component of the electromagnetic wave in the second direction of the polarisation vector obtained at the end of the normalisation step, then
repeating the steps of selecting, constructing a polarisation lookup table, correlating the normalised eigenvector with the polarisation lookup table, adjusting, constructing a third reference table, correlating the normalised eigenvector with the third reference table, and identifying a direction of arrival.

6. The method of claim 5, wherein the lookup space forms a spiral in a complex plane, and wherein updating the lookup space comprises expanding the spiral so that the new lookup space forms a new spiral in the complex plane which is expanded with respect to the spiral.

7. The method of claim 5, further comprising comparing the maximum correlation index of the third correlation spectrum and a predefined threshold, said repetition being carried out only if the maximum correlation index of the third correlation spectrum is less than the predefined threshold.

8. The method of claim 1, wherein the first direction and the second direction are orthogonal.

9. A computer-readable memory storing instructions executable by a computer in order to execute the method of claim 1.

10. A device for estimating the direction of arrival of an electromagnetic wave at an antenna array, the device comprising at least one processor configured to implement the method of claim 1.

11. A system comprising:
an antenna array configured to acquire signals being derived from an electromagnetic wave,
the device of claim 10 for estimating the direction of arrival of the electromagnetic wave at the antenna array on the basis of the signals.

12. A mobile carrier comprising the system of claim 11.

13. The mobile carrier of claim 12, wherein the mobile carrier is an aircraft.
